(19) United States
(12) Patent Application Publication
(10) Pub. No.: US 2009/0171873 A1
(43) Pub. Date: Jul. 2, 2009

(54) DETERMINING THE INTERESTINGNESS OF CONTENT UPDATE NOTIFICATIONS

(75) Inventors: Robert M. Dolin, Seattle, WA (US); Oludare Obasanjo, Renton, WA (US)

Correspondence Address: SENNIGER POWERS LLP (MSFT), 100 NORTH BROADWAY, 17TH FLOOR, ST. LOUIS, MO, 63102, US

(73) Assignee: MICROSOFT CORPORATION, Redmond, WA (US)

(21) Appl. No.: 11/967,762

(22) Filed: Dec. 31, 2007

(51) Int. Cl. G06E 1/00

(52) U.S. Cl. 706/20

(57) ABSTRACT

A notification server rates the interest a first user has in notifications associated with events generated by a plurality of interactions with an online community. The notification server receives a plurality of notifications for a first user from a plurality of other users indicating an event has occurred in response to the other users' interactions with the online community. Each notification is rated based on the connections between the first user and the user associated with the notification. The connections may indicate a type of relationship between the first user and the user associated with the notification or the connections may indicate the first user's interest in the event associated with the notification. Each notification is rated based on the connections. The rated notifications are displayed to the first user based on their respective ratings.

### BACKGROUND

Social networking services help users stay up-to-date with happenings among their online friends, family, networks, events, and groups. To do this, these services aggregate these updates into a list of notifications, but with hundreds of friends each potentially making dozens updates per week, this list can get very long very quickly.

For example, consider the following list of notifications:

Friend A added blog entry: “My morning run”

Friend B updated profile fields: interests

Group X added discussion: “Where should we hold our next meeting”

Friend C added blog entry: “Stuck on the bus”

Friend A added blog entry: “Vitamin I”

Friend D added video: “Silly Johnny”

Friend D added gadget: Video

Group Y added announcements: “Soccer practice canceled”

Some ways of filtering the list could include explicitly selecting notification types (e.g., Don't show blog entries or Show photos) or explicitly selected members (e.g., Don't show Friend D or Show Group Y). However, these techniques require the user to create customized filters and the filters will remain in place until the user changes the filters.

### SUMMARY

Embodiments of the invention overcome one or more of the difficulties associated with the filtering a list of notifications, each indicating an event has occurred to in an online community. Aspects of the invention rate the interest a first user has in notifications associated with events generated by a plurality of interactions with an online community. A notification server receives a plurality of notifications for a first user from a plurality of other users indicating an event has occurred in response to the other users' interactions with the online community. Each notification is rated based on the connections between the first user and the user associated with the notification. The connections may indicate a type of relationship between the first user and the user associated with the notification or the connections may indicate the first user's interest in the event associated with the notification. Each notification is rated based on the connections. The rated notifications are displayed to the first user based on their respective ratings.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Other features will be in part apparent and in part pointed out hereinafter.

### BRIEF DESCRIPTION OF THE DRAWINGS

FIG. 1 is a block diagram illustrating one example of a suitable computing system environment in which the invention may be implemented.

FIG. 2 is a flow diagram for a method for rating the interest a first user has in a events generated in response to said second user's interactions with an online community.

FIG. 3 is a flow diagram for a method for rating the interest a first user has in events generated in response to a plurality of interactions with an online community.

FIG. 4 is a flow diagram for another embodiment of a method for rating the interest a first user has in events generated in response to a plurality of interactions with an online community.

Corresponding reference characters indicate corresponding parts throughout the drawings.

### DETAILED DESCRIPTION

Referring now to the drawings, aspects of the invention includes a notification server for rating the interest a first user has in notifications associated with events generated in response to a plurality of interactions with an online community. The user may receive hundreds of notifications from a variety of online social networking services of the online community indicating a change has been made to a content set or that another user has interacted with the online community (e.g., sent the user a SMS message). The online community provides a collection of various tools for users to interact, such as chat, messaging, email, video, voice chat, file sharing, blogging, discussion groups, and so on. The content set is any content created in relation to these tools and is part of the online community. Additionally, the content set of a user includes the user's web space (if it exists).

Users may become overwhelmed by long and unwieldy lists of notifications, and consequently, the ability to filter of such lists is important to the user experience.

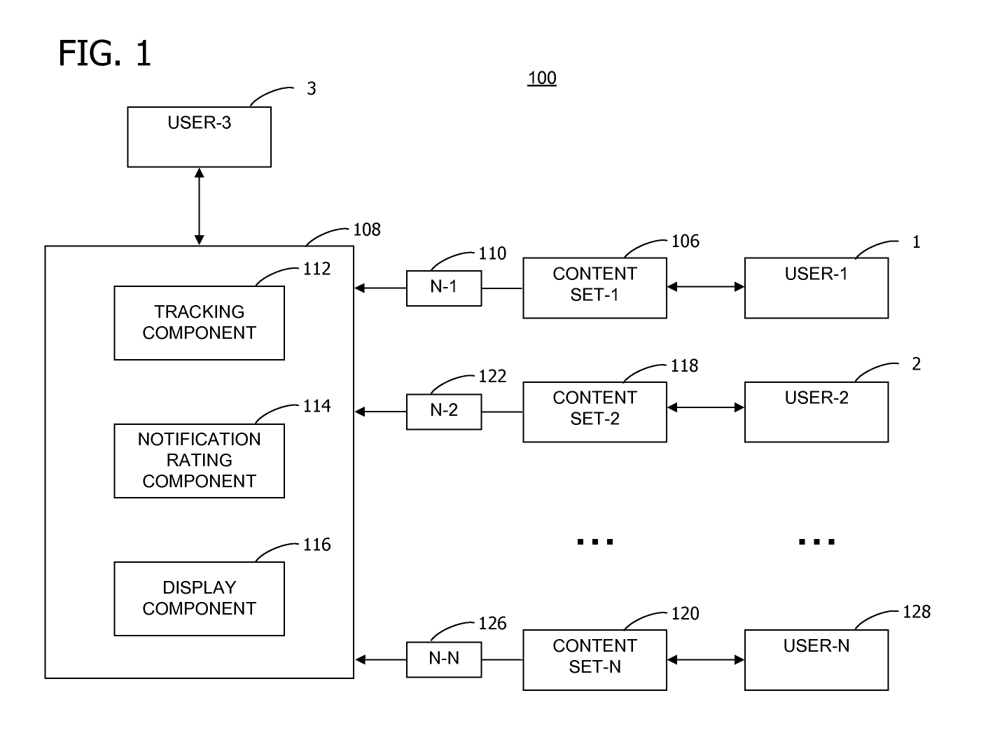

FIG. 1 is a block diagram illustrating one example of a suitable computing system environment for rating the interest a third user 3 has in a first user's 1 events generated in response to the first user's 1 interaction with the online community 100. The first user's 1 interactions include the modification of a web space 106 or another interaction with the online community members (e.g., user-1 1, user-2 2, user-3 3, user-N 128). For example, the second user 2 sends a SMS message to the third user 3 and the third user 3 receives a notification that the message was sent.

A notification server 108 receives a plurality of notifications (e.g., N-1 110), each notification indicating an event related to the first user's 1 interactions with the online community 100 has occurred. Each notification is generated in response to the event. In an embodiment, the events include one or more of the following: a new blog entry in the first user's 1 content set, a new photo uploaded to the first user's 1 content set, a new photo posted to a shared group or event, a new hyperlink posted in the content set of the second user, a new hyperlink posted in the content set of a shared group, a new hyperlink posted in the content set of a shared event, a new comment added to a content set, the third user being sent an electronic communication by the second user, a new discussion entry on a group page of a content set; a new list entry in the first user's 1 content set, a new video uploaded to the first user's 1 content set, a new announcement added to a group page.

The tracking component 112 of the notification server 108 determines a plurality of connections between the third user 3 and the first user 1. The connection indicates the interest the third user 3 has in the events related to of the first user's 1 interaction with the online community 100. In an embodiment, the connections include one or more of the following: the third user 3 and first user 1 have at least one common interest indicated in their respective profiles, the third user 3 and first user 1 include the same organization in their respective profiles, the third user 3 and first user 1 have a third user in common in their respective address books, the third user 3 and first user 1 share a familiar connection, the third user 3 and first user 1 belong to at least one common group, the third user 3 and first user 1 have a third user in a similarly named instant messenger contact list, the third user 3 and first user 1 have a third user in an instant messenger contact list, the third user 3 has sent an electronic communication to the second user, the first user 1 has sent an electronic communication to the third user 3, the third user 3 has viewed the second user's content set, the first user 1 has viewed the third user 3's content set, the third user 3 has interacted with the second user's content set, and the first user 1 has interacted with the third user 3's content set. For example, a connection is determined if both the first user 1 and the third user 3 have a contact named John Smith in their respective “co-workers” category of an instant messenger contact list.

The notification rating component 114 rates the interest of the third user 3 in each notification (e.g., N-1 110) based on the determined connections and the event indicated by the notification. In an embodiment, a connection is weighted more in the rating of the notification if it occurred within a first period of time and the connection is weighted less in the rating of the notification if it occurred outside of a second period of time.

For example, suppose the third user 3 had a great interest in scuba diving in the past. The third user 3 frequently read announcements posted groups associated with scuba diving, visited blogs regarding scuba diving, and send frequent messages to friends in a “scuba buddies” friends list the third user 3 created. But after a few years, the third user's 3 interest in scuba diving waned. The third user 3 only occasionally reads announcements posted groups associated with scuba diving, does not visit blogs regarding scuba diving any more, and rarely sends frequent messages to friends in a “scuba buddies” friends list the third user 3 created. Instead, the first user has taken up bungee jumping. Now, the third user 3 frequently read announcements posted groups associated with bungee jumping, visits blogs regarding bungee jumping, and sends frequent messages to friends in a “bungee buddies” friends list the third user 3 created. In this case, connections related to bungee jumping will be weighted more in the rating of the notification and the connections related to scuba diving will weighted less in the rating of the notification related to scuba diving because most of the scuba diving connections occurred a year or two in the past while the connections related to bungee jumping are currently occurring with a great frequency. Advantageously, over time, the rating of a notification related to a topic (scuba diving) or a person (scuba buddy) will automatically adapt as the third user 3 changes social networking interactions.

In another embodiment, the rating of the notification is weighted by the number of tracked click-throughs and page views the third user 3 has had with the first user's 1 content set 106. A click-through indicates how often the third user 3 has clicked on an update from the first user 1. A page view indicates how often the third user 3 has visited the content set 106 of the first user 1.

The display component 116 displays the plurality of notifications to the third user 3 based on their respective ratings such that the notification of most interest to the user is displayed with a higher priority.

In another embodiment, the notification server 108 rates the interest the third user 3 has in events related to a plurality of interactions with the online community 100. The notification server 108 receives a first notification 110 from the first user 1 indicating a first event has occurred related to the first user's 1 interaction with the online community 100. The first notification 110 is generated in response to the first event and includes an identity of the first user 1. The notification server 108 also receives a second notification 122 from a second user 2 indicating a second event related to the second user's 2 interaction with the online community 100 has occurred. The second notification 122 is generated in response to the second event and includes an identity of the second user 2.

In this embodiment, the tracking component 112 first determines a plurality of connections between the third user 3 and the first user 1. The connection indicates a type of relationship the third user 3 has with the first user 1. Next, the notification rating component 114 first rates the interest of the third user 3 in the first notification 110 is based on the first determined connections and identity of the first user 1.

Furthermore, the tracking component 112 second determines a plurality of connections between the third user 3 and the second user 2. The connection indicates a type of relationship the third user 3 has with the second user 2. Next, the notification rating component 114 second rates the interest of the third user 3 in the second notification 122 based on the second determined connections and identity of the second user 2.

In this embodiment, the display component 116 displays the first notification 110 and second notification 122 to the third user 3 based their respective ratings such that the notification of most interest to the third user 3 is displayed with a higher priority.

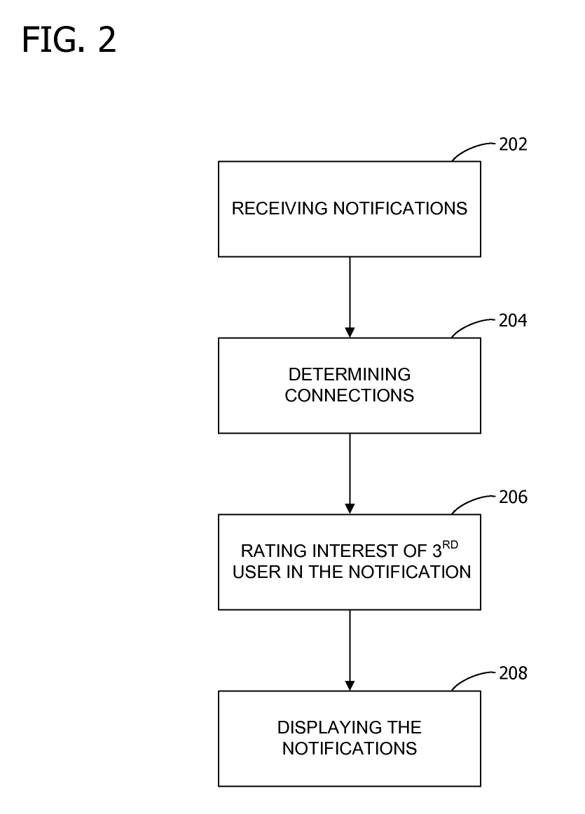

FIG. 2 is a flow diagram for a method for rating the interest a third user 3 has in a first user's 1 events related to said first user's 1 interactions with an online community 100. At 202, the notification server 108 receives a plurality of notifications (e.g., N-1 110), each notification indicating an event related to the first user's 1 interaction with the online community 100 has occurred. Each notification is generated in response to the event. In an embodiment, the events include one or more of the following: a new blog entry in the first user's 1 content set, a new photo uploaded to the first user's 1 content set, a new photo posted to a shared group or event, a new hyperlink posted in the content set of the second user, a new hyperlink posted in the content set of a shared group, a new hyperlink posted in the content set of a shared event, a new comment added to a content set, a new electronic communication has been sent to the first user, a new discussion entry on a group page of a content set; a new list entry in the first user's 1 content set, a new video uploaded to the first user's 1 content set, a new announcement added to a group page.

At 204, the tracking component 112 of the notification server 108 determines a plurality of connections between the third user 3 and the first user 1. The connection indicates the interest the third user 3 has in the event related to the first user's 1 interaction with the online community 100. In an embodiment, the connections include one or more of the following: the third user 3 and first user 1 have at least one common interest indicated in their respective profiles, the third user 3 and first user 1 include the same organization in their respective profiles, the third user 3 and first user 1 have a second user 2 in common in their respective address books, the third user 3 and first user 1 share a familiar connection, the third user 3 and first user 1 belong to at least one common group, the third user 3 and first user 1 have a second user 2 in a similarly named instant messenger contact list, the third user 3 and first user 1 have a second user 2 in an instant messenger contact list, the third user 3 has sent an electronic communication to the first user 1, the first user 1 has sent an electronic communication to the first user, the third user 3 has viewed the second user's content set, the first user 1 has viewed the third user's 3 content set, the third user 3 has interacted with the second user's content set, and the first user 1 has interacted with the third user's 3 content set.

At 206, the notification rating component 114 rates the interest of the third user 3 in each notification (e.g., N-1 110) based on the determined connections and the event indicated by the notification. In an embodiment, the notification rating component 114 weights a connection more in the rating of the notification if it occurred within a first period of time and weights the connection less in the rating if it occurred outside of a second period of time. In another embodiment, the rating of the notification is weighted by the number of tracked click-throughs and/or page views the third user 3 has had with the first user's 1 content set 106.

In yet another embodiment, a direct connection includes one or more of the following: the third user 3 has sent an electronic communication to the first user 1, the first user 1 has sent an electronic communication to the first user, the third user 3 has viewed the second user's content set, the first user 1 has viewed the third user's 3 content set, the third user 3 has interacted with the second user's content set, and the first user 1 has interacted with the third user's 3 content set and an indirect connection includes one or more of the following: the third user 3 and first user 1 have at least one common interest indicated in their respective profiles, the third user 3 and first user 1 include the same organization in their respective profiles, the third user 3 and first user 1 have a second user 2 in common in their respective address books, the third user 3 and first user 1 belong to at least one common group, the third user 3 and first user 1 have a second user 2 in a similarly named instant messenger contact list, and the third user 3 and first user 1 have a second user 2 in an instant messenger contact list. In this embodiment, the rating of each notification indicates the notification a greater interest to the third user 3 if the connections between the third user 3 and first user 1 are direct connections and the rating of a notification indicates a lesser interest to the third user 3 if the connections between the third user 3 and first user 1 are indirect connections.

At 208, the display component 116 displays the plurality of notifications to the third user 3 based on their respective ratings such that the notification of most interest to the user is displayed with a higher priority. For example, the notifications may be displayed in order of their ratings. Alternatively, notifications with a rating over a threshold may be highlighted or bolded in the display. In another alternative, only notifications with a rating over a threshold will be displayed by the display component 116.

In an embodiment, the tracking component 112 tracks the connections the third user 3 has with other members (e.g., user-1, user-2, user-N 128) of an online community 100. Additionally, the tracking component 112 determines a plurality of categories based the tracked connections and calculates a first weight for each category based on the tracked connections. Each category represents an interest of the third user 3.

In this embodiment, the notification rating component 114 associates each notification (e.g., N-1 110, N-2 122, N-N 126) with the plurality categories and calculates a second weight for each notification based on the calculated first weights of the categories associated with each notification. At 206, the notification rating component 114 rates the interest of the third user 3 in each notification based on the determined connections, the event indicated by the notification, and the calculated second weight of the notification.

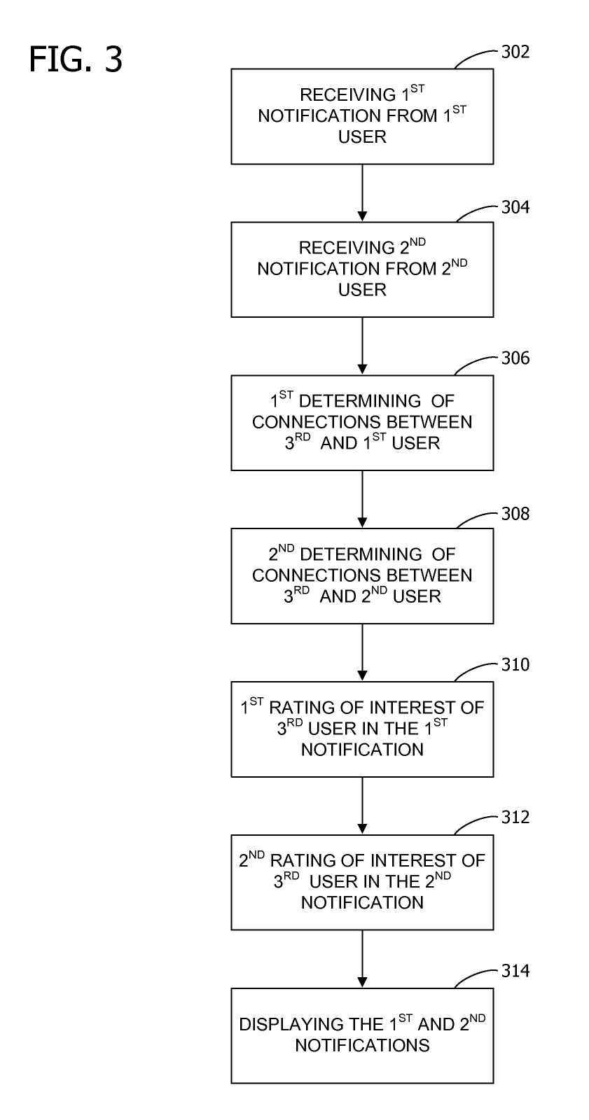

FIG. 3 is a flow diagram for a method for rating the interest a third user 3 has in events related to a plurality of interactions with an online community 100. In an embodiment, the events include one or more of the following: a new blog entry in the content set, a new photo uploaded to a content set, a new photo posted to a shared group or event, a new hyperlink posted in the content set of the second user, a new hyperlink posted in the content set of a shared group, a new hyperlink posted in the content set of a shared event, a new comment added to a content set, the third user being sent an electronic communication by the second user, a new discussion entry on a group page of a content set; a new list entry in a content set, a new video uploaded to a content set, a new announcement added to a group page.

At 302, the notification server 108 receives a first notification 110 from a first user 1 indicating a first event related to the first user's 1 interaction with the online community 100 has occurred. The first notification 110 is generated in response to the first event and includes an identity of the first user 1. And, at 304, the notification server 108 also a second notification 122 from a second user 2 indicating a second event related to the second user's 2 interaction with the online community 100 has occurred. The second notification 122 is generated in response to the second event and includes an identity of the second user 2.

First, at 306, the tracking component 112 determines a plurality of connections between the third user 3 and the first user 1. The connection indicates a type of relationship the third user 3 has with the first user 1. Second, at 308, the tracking component 112 determines a plurality of connections between the third user 3 and the second user 2. The connection indicates a type of relationship the third user 3 has with the second user 2. In an embodiment, the connections that indicate a type of relationship between two users include one or more of the following: the two user have at least one common interest indicated in their respective profiles, the two users include the same organization in their respective profiles, the two users have a fourth user in common in their respective address books, the two users share a familiar connection, two users belong to a common group, the two users have exchanged at least one an electronic communication, and at least one of the two users has interacted with the other user's content set.

At 310, the notification rating component 114 first rates the interest of the third user 3 in the first notification 110 is based on the first determined connections and identity of the first user 1. At 312, the notification rating component 114 second rates the interest of the third user 3 in the second notification 122 based on the second determined connections and identity of the second user 2. In an embodiment, the first rating of the first notification 110 is weighted by the amount of electronic communication the third user 3 has had with the first user 1 relative to other users (e.g., user-2, user-N 128) within a period of time and the second rating of the second notification 122 is weighted by the amount of electronic communication the third user 3 has had with the second user 2 relative to other users (e.g., user-1, user-N 128) within a period of time.

In another embodiment, each connection is weighted more in the rating of the notification (e.g., N-1 110, N-2 122) if the connection occurred within a first period of time and the connection is weighted less in the rating if the connection occurred outside of a second period of time. And, in yet another embodiment, the rating of each notification (e.g., N-1 110, N-2 122) is weighted by the number of tracked click-throughs and/or page views the third user 3 has had with content set associated with the notification.

At 314, the display component 116 displays the first notification 110 and second notification 122 to the third user 3 based their respective ratings such that the notification of most interest to the third user 3 is displayed with a higher priority.

In an embodiment, at 306, the tracking component 112 first determines a plurality of connections between the third user 3 and the first user 1 such that the connection indicates the interest the third user 3 has in the event related to the first user's 1 interaction with the online community 100. In this embodiment, at 308, the tracking component 112 second determining a plurality of connections between the third user 3 and the second user 2 such that the connection indicates the interest the third user 3 has in the event related to the third user's interaction with the online community 100.

And, in this embodiment, at 310, the notification rating component 114 first rates the interest of the third user 3 in the first notification based on the determined connections, identity of the first user 1, and event indicated by the first notification. Furthermore, at 312, the notification rating component 114 second rating the interest of the third user 3 in the first notification based on the determined connections, identity of the second user 2, and event indicated by the second notification 122.

In another embodiment, the tracking component 112 tracks the connections the third user 3 has with other members (e.g., user-1, user-2, user-N 128 of the online community 100. Furthermore, the tracking component 112 determines a plurality of categories based the tracked connections and calculates a weight for each category based on the tracked connections. Each category represents an interest of the third user 3.

For example, suppose the third user 3 visits the content set 106 of the first user 1 and views the photos posted in the content set 106. This connection between the third user 3 and first user 1 indicates that the third user 3 is interested in the first user 1 and the third user 3 is interested in photos. This allows the tracking component 112 to calculate weights for categories. For example, if the third user 3 regularly visits content sets and views photos but does not view videos, the weight assigned to the “photo” category would be high so that notifications of events related to photo content sets will be rated high. Conversely, the weight assigned to the “video” category would be low so that notifications of events related to video content sets will be rated low.

In this embodiment, the tracking component 112 first associates the first notification 110 with the plurality categories and calculates a first notification weight for the first notification 110 based on the calculated weights of the categories associated with the first notification 110. And, at 310, the notification rating component 114 first rates of the first notification 110 based on the first determined connections, the first event indicated by the first notification, and the first notification weight.

Additionally, in this embodiment, the tracking component 112 second associates the second notification 122 with the plurality categories and calculates a second notification weight for the second notification 112 based on the calculated weights of the categories associated with the second notification 112. And, at 312, the notification rating component 114 second rates the second notification 122 based on the second determined connections, the second event indicated by the second notification, and the second notification weight.

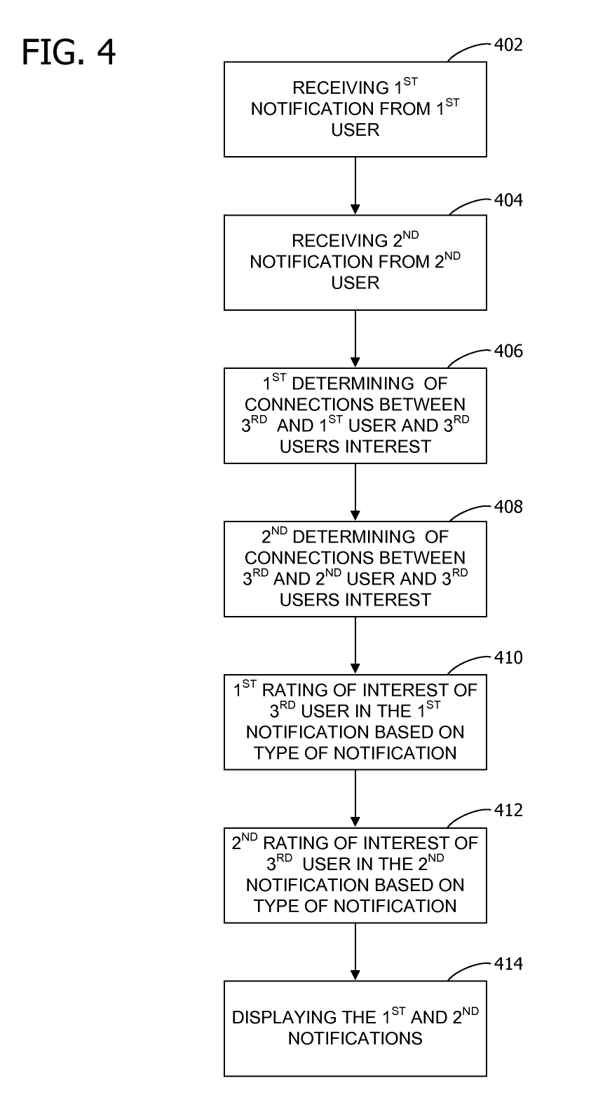

FIG. 4 is a flow diagram for a method for rating the interest a third user 3 has in events related to a plurality of interactions with an online community. At 402, the notification server 108 receives a first notification 110 from a first user 1 indicating a first event related to the first user's 1 interaction with the online community 100 has occurred. The first notification 110 is generated in response to the first event and includes an identity of the first user 1. And, at 404, the notification server 108 also a second notification 122 from a second user 2 indicating a second event related to the second user's 2 interaction with the online community 100 has occurred. The second notification 122 is generated in response to the second event and includes an identity of the second user 2.

First, at 406, the tracking component 112 determines a plurality of connections between the third user 3 and the first user 1. The connection indicates a type of relationship the third user 3 has with the first user 1 and indicates the interest the third user 3 has in the event related to the first user's 1 interaction with the online community 100. Second, at 408, the tracking component 112 determines a plurality of connections between the third user 3 and the second user 2. The connection a type of relationship the third user 3 has with the second user 2 and indicates the interest the third user 3 has in the event related to the second user's 2 interaction with the online community 100.

At 410, the notification rating component 114 first rates the interest of the third user 3 in the first notification 110 is based on the first determined connections and identity of the first user 1, and the event indicated by the first notification 110. At 412, the notification rating component 114 second rates the interest of the third user 3 in the second notification 122 based on the second determined connections, identity of the second user 2, and the event indicated by the second notification 122.

For example, suppose two users, Rob and Dare, are good friends. They send email to each other regularly, include each other in their respective address books, and visit each other content sets often. Based on these connections, Rob and Dare's friend relationship would be rated high (0.9). Also, suppose that Rob does not visit blog sites often, thus his interest in blogs is moderate (0.5). Now suppose Rob receives a notification that Dare has added an entry to the blog of his content set. The rating of notification would be 0.45 (Interest in Dare*Interest in blogs).

In an embodiment, the rating of each notification (e.g., N-1 110, N-2 122) is weighted by the number of tracked click-throughs and/or page views the third user 3 has had with content set associated with the notification. In another embodiment, the each connection is weighted more in the rating of the notification (e.g., N-1 110, N-2 122) if the connection occurred within a first period of time and the connection is weighted less in the rating if the connection occurred outside of a second period of time. And in yet another embodiment, the first rating of the first notification 110 is weighted by the amount of electronic communication the third user 3 has had with the first user 1 relative to other users (e.g., user-2, user-N 128) within a period of time and the second rating of the second notification 122 is weighted by the amount of electronic communication the third user 3 has had with the second user 2 relative to other users (e.g., user-1, user-N 128) within a period of time.

At 314, the display component 116 displays the first notification 110 and second notification 122 to the third user 3 based their respective ratings such that the notification of most interest to the third user 3 is displayed with a higher priority.

Referring again to FIG. 1, FIG. 1 shows one example of a general purpose computing device in the form of a notification server 108. In one embodiment of the invention, a computer such as the notification server 108 is suitable for use in the other figures illustrated and described herein. The notification server 108 has one or more processors or processing units and a system memory.

The notification server 108 typically has at least some form of computer readable media. Computer readable media, which include both volatile and nonvolatile media, removable and non-removable media, may be any available medium that may be accessed by notification server 108. By way of example and not limitation, computer readable media comprise computer storage media and communication media.

Computer storage media include volatile and nonvolatile, removable and non-removable media implemented in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by computer notification server 108.

Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media.

The drives or other mass storage devices and their associated computer storage media, provide storage of computer readable instructions, data structures, program modules (e.g., tracking component 112, notification rating component 114, display component 116) and other data for the notification server 108.

The notification server 108 may operate in a networked environment using logical connections to one or more remote computers, such as a computer hosting content set-1 106, content set-2 118, and content set-N 120. The remote computer may be a personal computer, a server, a router, a network PC, a peer device or other common network node, and typically includes many or all of the elements described above relative to notification server 108. The logical connections depicted in FIG. 1 include a local area network (LAN) and a wide area network (WAN), but may also include other networks. LAN and/or WAN may be a wired network, a wireless network, a combination thereof, and so on. Such networking environments are commonplace in offices, enterprise-wide computer networks, intranets, and global computer networks (e.g., the Internet).

In a networked environment, program modules (e.g., tracking component 112, notification rating component 114, display component 116) depicted relative to notification server 108, or portions thereof, may be stored in a remote memory storage device (not shown). By way of example, and not limitation, FIG. 1 illustrates remote application programs as residing on the memory device. The network connections shown are exemplary and other means of establishing a communications link between the computers may be used.

Generally, the data processors of notification server 108 are programmed by means of instructions stored at different times in the various computer-readable storage media of the computer. Programs and operating systems are typically distributed, for example, on floppy disks, CD-ROMs or via a network. From there, they are installed or loaded into the secondary memory of a computer. At execution, they are loaded at least partially into the computer's primary electronic memory. Aspects of the invention described herein includes these and other various types of computer-readable storage media when such media contain instructions or programs for implementing the steps described below in conjunction with a microprocessor or other data processor. Further, aspects of the invention include the computer itself when programmed according to the methods and techniques described herein.

For purposes of illustration, programs and other executable program components, such as the operating system, are illustrated herein as discrete blocks. It is recognized, however, that such programs and components reside at various times in different storage components of the computer, and are executed by the data processor(s) of the computer.

Although described in connection with an exemplary computing system environment, including notification server 108, embodiments of the invention are operational with numerous other general purpose or special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the exemplary operating environment. Examples of well known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. Generally, program modules include, but are not limited to, routines, programs, objects, components, and data structures that perform particular tasks or implement particular abstract data types. Aspects of the invention may also be practiced in distributed computing environments where tasks are performed by remote processing devices that are linked through a communications network. In a distributed computing environment, program modules may be located in both local and remote computer storage media including memory storage devices.

In operation, notification server 108 executes computer-executable instructions such as those illustrated in the figures to implement aspects of the invention.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Embodiments of the invention may be implemented with computer-executable instructions. The computer-executable instructions may be organized into one or more computer-executable components or modules. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A method for rating the interest a first user has in an event generated by second user's interaction with an online community, comprising:
receiving a plurality of notifications, each notification indicating an event has occurred related to the second user's interaction with the online community, each notification generated in response to said event;
determining a plurality of connections between the first user and the second user wherein the connection indicates the interest the first user has in event generated by the second user's interaction with the online community;
rating the interest of the first user in each notification based on the determined connections and the event indicated by the notification; and
displaying the plurality of notifications to the first user based on their respective ratings such that the notification of most interest to the user is displayed with a higher priority.

2. The method of claim 1, further comprising:
tracking the connections the first user has with other members of an online community;
determining a plurality of categories based the tracked connections wherein each category represents an interest of the first user;
calculating a first weight for each category based on the tracked connections;
associating each notification with a selected one of the plurality categories and calculating a second weight for the notification based on the calculated first weight of the selected category associated with the notification wherein rating the interest of the first user in each notification is based on the determined connections, the event indicated by the notification, and the second weight of the notification.

3. The method of claim 1, wherein the connections include one or more of the following: the first user and second user have at least one common interest indicated in their respective profiles, the first user and second user include the same organization in their respective profiles, the first user and second user have a third user in common in their respective address books, the first user and second user share a familiar connection, the first user and second user belong to at least one common group, the first user and second user have a third user in a similarly named instant messenger contact list, the first user and second user have a third user in an instant messenger contact list, the first user has sent an electronic communication to the second user, the second user has sent an electronic communication to the first user, the first user has viewed a content set within the online community of the second user, the second user has viewed a content set within the online community of the first user, the first user has interacted with a content set within the online community of the second user, and the second user has interacted with a content set within the online community of the first user's.

4. The method of claim 3, wherein a direct connection includes one or more of the following:
the first user has sent an electronic communication to the second user, the second user has sent an electronic communication to the first user, the first user has viewed the second user's content set, the second user has viewed the first user's content set, the first user has interacted with the second user's content set, and the second user has interacted with the first user's content set; and
an indirect connection includes one or more of the following: the first user and second user have at least one common interest indicated in their respective profiles, the first user and second user include the same organization in their respective profiles, the first user and second user have a third user in common in their respective address books, the first user and second user belong to at least one common group, the first user and second user have a third user in a similarly named instant messenger contact list, and the first user and second user have a third user in an instant messenger contact list.

5. The method of claim 4, wherein the rating of a notification indicates a greater interest to the first user if the connections between the first and second user are direct connections and the rating of a notification indicates a lesser interest to the first user if the connections between the first and second user are indirect connections.

6. The method of claim 1, wherein the events include one or more of the following: a new blog entry in a content set within the online community the second user, a new photo uploaded to a content set within the online community of the second user, a new photo posted to a shared group or event, a new hyperlink posted in a content set within the online community of the second user, a new hyperlink posted in a content set within the online community of a shared group, a new hyperlink posted in a content set within the online community of a shared event, a new comment added to a content set within the online community, a new electronic communication has been sent to the first user, a new discussion entry on a group page of a content set within the online community; a new list entry in a content set within the online community of the second user, a new video uploaded to a content set within the online community of the second user, a new announcement added to a group page.

7. The method of claim 1, wherein the rating of the notification is rated based on the period of time during which the event occurred.

8. The method of claim 1, wherein the rating of the notification is rated based on the number of tracked click-throughs and page views the first user has had with a content set within the online community of the second user.

9. A method for rating the interest a first user has in events related to a plurality of interactions with an online community, comprising:
receiving a first notification from a second user indicating a first event has occurred related to the second user's interaction with the online community, said first notification generated in response to said first event and including an identity of the second user;
receiving a second notification from a third user indicating a second event has occurred related to the third user's interaction with the online community, said second notification generated in response to said second event and including an identity of the third user;
first determining a plurality of connections between the first user and the second user wherein the connection indicates a type of relationship the first user has with the second user;
first rating the interest of the first user in the first notification is based on the first determined connections and identity of the second user;
second determining a plurality of connections between the first user and the third user wherein the connection indicates a type of relationship the first user has with the third user;
second rating the interest of the first user in the second notification is based on the second determined connections and identity of the third user; and
displaying the first and second notifications to the first user based their respective ratings such that the notification of most interest to the first user is displayed with a higher priority.

10. The method of claim 9, wherein the first and second determining comprises:
first determining a plurality of connections between the first user and the second user wherein the connection indicates the interest the first user has in the events related to the second user's interaction with the online community;
second determining a plurality of connections between the first user and the third user wherein the connection indicates the interest the first user has in the events related to the third user's interaction with the online community; and wherein the first and second rating comprises
first rating the interest of the first user in the first notification based on the determined connections, identity of the second user, and event related to the second user's interaction with the online community indicated by the first notification; and
second rating the interest of the first user in the first notification based on the determined connections, identity of the third user, and event related to the third user's interaction with the online community indicated by the second notification.

11. The method of claim 9, wherein the first rating of the first notification is based on the amount of electronic communication the first user has had with the second user relative to other users within a period of time and wherein the second rating of the second notification is based on the amount of electronic communication the first user has had with the third user relative to other users within a period of time.

12. The method of claim 9, further comprising:
tracking the connections the first user has with other members of an online community;
determining a plurality of categories based the tracked connections wherein each category represents an interest of the first user;
calculating a weight for each category based on the tracked connections;
first associating the first notification with the plurality categories and calculating a first notification weight for the first notification based on the calculated weights of the categories associated with the first notification wherein the first rating of the first notification is based on the first determined connections, the first event indicated by the first notification, and the first notification weight; and
second associating the second notification with a selected one of the plurality categories and calculating a second notification weight for the second notification based on the calculated weight of the selected category associated with the second notification wherein the second rating of the second notification is based on the second determined connections, the second event indicated by the second notification, and the second weight of the notification.

13. The method of claim 9, wherein the connections that indicate a type of relationship between two users include one or more of the following: the two user have at least one common interest indicated in their respective profiles, the two users include the same organization in their respective profiles, the two users have a fourth user in common in their respective address books, the two users share a familiar connection, two users belong to a common group, the two users have exchanged at least one an electronic communication, and at least one of the two users has interacted with a content set within the online community the other user.

14. The method of claim 9, wherein the events include one or more of the following: a new blog entry in the content set within the online community, a new photo uploaded to a content set within the online community, a new photo posted to a shared group or event, a new hyperlink posted in the content set within the online community of the second user, a new hyperlink posted in the content set within the online community of a shared group, a new hyperlink posted in the content set within the online community of a shared event, a new comment added to a content set within the online community, the first user being sent an electronic communication by the second user, a new discussion entry on a group page of a content set within the online community; a new list entry in a content set within the online community, a new video uploaded to a content set within the online community, a new announcement added to a group page.

15. The method of claim 9, wherein if the first determined connection occurred within a first period of time the first determined connection is rated higher in the first rating of the first notification and the first determined connection is rated lower in the first rating of the first notification if it occurred outside of a second period of time; and
wherein if the second determined connection occurred within the first period of time the second determined connection is rated higher in the second rating of the second notification and the second determined connection is rated lower in the first rating of the second notification if it occurred outside of the second period of time.

16. The method of claim 9, wherein the first rating of the first notification is rated based on the number of tracked click-throughs and page views the first user has had with a content set within the online community of the second user and the second rating of the second notification is rated based on the number of tracked click-throughs and page views the first user has had with a content set within the online community of the third user.

17. A method for rating the interest a first user has in events related to a plurality of interactions with an online community, comprising:
receiving a first notification from a second user indicating a first event has occurred related to the second user's interaction with the online community, said first notification generated in response to said first event and including an identity of the second user;
receiving a second notification from a third user indicating a second event has occurred related to the third user's interaction with the online community, said second notification generated in response to said second event and including an identity of the third user;
first determining a plurality of connections between the first user and the second user wherein each connection indicates a type of relationship the first user has with the second user and indicates the interest the first user has in the events related to the second user's interactions with the online community;
first rating the interest of the first user in the first notification is based on the first determined connections, identity of the second user, and the event indicated by the first notification;
second determining a plurality of connections between the first user and the third user wherein each connection indicates a type of relationship the first user has with the third user and indicates the interest the first user has in the events related to the third user's interaction with the online community;
second rating the interest of the first user in the first notification is based on the second determined connections, identity of the third user, and the event indicated by the second notification; and
displaying the first and second notifications to the first user based their respective ratings such that the notification of most interest to the first user is displayed with a higher priority.

18. The method of claim 17, wherein the first rating of the first notification is rated based on the number of tracked click-throughs and page views the first user has had with a content set within the online community of the second user and the second rating of the second notification is rated based on the number of tracked click-throughs and page views the first user has had with a content set within the online community of the third user.

19. The method of claim 17, wherein if the first determined connection occurred within a first period of time the first determined connection is rated higher in the first rating of the first notification and the first determined connection is rated lower in the first rating of the first notification if it occurred outside of a second period of time; and
wherein if the second determined connection occurred within the first period of time the second determined connection is rated higher in the second rating of the second notification and the second determined connection is rated lower in the first rating of the second notification if it occurred outside of the second period of time.

20. The method of claim 17, wherein the first rating of the first notification is rated based on the amount of electronic communication the first user has had with the second user relative to other users within a period of time and wherein the second rating of the second notification is rated based on the amount of electronic communication the first user has had with the third user relative to other users within a period of time.
